(19) United States
(12) Patent Application Publication
(10) Pub. No.: US 2010/0053464 A1
(43) Pub. Date: Mar. 4, 2010

(54) STATIONARY REMOTE CONTROL TRANSMITTING DEVICE

(75) Inventor: Kenji Otsuka, Tokyo (JP)

Correspondence Address: DARBY & DARBY P.C., P.O. BOX 770, Church Street Station, New York, NY, 10008-0770, US

(73) Assignee: SMK Corporation, Tokyo (JP)

(21) Appl. No.: 12/405,406

(22) Filed: Mar. 17, 2009

(30) Foreign Application Priority Data
Sep. 1, 2008 (JP) 2008-224128

(51) Int. Cl. H04N 5/44

(52) U.S. Cl. 348/734; 348/E07.001

(57) ABSTRACT

In a controlling mode wherein control content for rotational operation control of a controlled device has been selected through an inputting operation of an inputting switch, a displaying unit that is provided on a surface of a case that is displayed on the rotational center axis side of an operating unit displays the rotational operation directions for rotational operation control, to perform rotational operation control of a controlled device in a rotational operation direction displayed on the displaying unit by a rotational operation of an operating unit in a direction that matches the rotational operation direction that is displayed on the displaying unit.

### CROSS REFERENCE TO RELATED APPLICATION

This application claims priority under 35 U.S.C. §119 to Japanese Patent Application No. 2008-224128 filed Sep. 1, 2008. The contents of that application, in their entirety, are incorporated herein by reference.

### FIELD OF TECHNOLOGY

The present invention relates to a stationary remote control transmitting device for performing control by transmitting control data to a controlled device, and, more specifically, relates to a stationary remote control transmitting device provided with an operating unit for rotational operations.

### BACKGROUND OF THE INVENTION

Conventionally, there are known remote control transmitting devices, as remote control transmitting devices for remotely controlling a video player device such as a DVD recorder, whereon a so-called “jog dial” annular dial key is attached to a case rotatably, and frame-by-frame or variable speed playback control of images recorded on the DVD recorder is performed in accordance with rotational operations of the jog dial. (Japanese Unexamined Patent Application Publication 2007-36508, (“JP '508”) page 3, lines 36 through 50, page 4, lines 26 through 32, FIG. 1, and FIG. 3).

In this type of remote control transmitting device, the control content (for example, power supply ON and OFF, Fast-Forward, Rewind, Play, etc.) is displayed on a displaying unit, such as a liquid crystal panel, and after selecting a control content using a Send key that is attached to the case separately from the jog dial, then, if, for example, “Play” were selected, then control data in accordance with the angle of rotation by the rotational operation of the jog dial is sent to the DVD recorder, to perform the frame-by-frame playback control of the recorded video.

Additionally, there is a known remote control transmitting device for remote control of a rotational operation for adjusting the slat angle of an electrically powered blind. (Japanese Unexamined Patent Application Publication 2000-240375, (“JP '375”) page 3, block 4, line 35 through page 4, block 5, line 13, FIG. 1, and FIG. 2). A pair of inputting switches, respectively marked with the slat orientations of Right-Down and Right-Up, are attached on the surface of a remote control transmitting device, so that when the inputting operations are performed on the individual inputting switches, an infrared remote control signal RS that includes the control data for controlling the operation of the motor for adjusting the slat angle is sent to the electric blind to which the remote control transmitter is facing.

The control data from the pair of inputting switches controls the rotational operation of the slat angle adjusting motor in the forward and reverse directions, and when there is an inputting operation of the inputting switch that is marked with the Right-down slat orientation, the slats are rotated to the Right-down orientation thereby, and when there is an inputting operation of the inputting switch that is marked with the Left-down slat orientation, rotational operation control is performed so as to rotate the slat so that the left will be down. Consequently, the optimal level of illumination can be obtained through controlling the rotational orientation of the slat as desired through inputting operations of either of the inputting switches.

The remote control transmitting device as set forth in JP '508 is formed in a rectangular shape, so as to enable holding of the case in a hand, and a displaying unit, for displaying a plurality of control content and a jog dial, which is an annular operating unit, are attached, separated into a top and bottom in the lengthwise direction. Consequently, because the displaying unit is separated from the jog dial, it is not possible to provide guidance through the display, on the displaying unit, of the rotational direction of the jog dial for performing the desired control, and thus there is a problem in that it is not possible to convey to the user the direction to which the rotational operation should be made.

Additionally, when performing rotational operation control of a controlled device in accordance with the rotational operation of the jog dial, in some cases the rotational operation directions of the controlled device will be opposite from the rotational operation directions of the jog dial, depending on the relative positioning of the remote control device and the controlled device, causing the operator to mistake the rotational operation direction on the jog dial, or causing the operator a sense of unease when performing the rotational operations.

Additionally, the remote control transmitting device as set forth in JP '375 displays, on the inputting switch, the rotational orientation of the controlled device for which the rotational operational control is to be performed, to provide guidance for the rotational operation directions for the controlled device through the inputting operations of the inputting switches. However, there is no relationship whatsoever between the downward direction of the operation of the switch used for the inputting operation of the inputting switch and the rotational orientation or rotational operation direction of the controlled device, and hence, similarly, the inputting operations have been accompanied by a sense of confusion.

Furthermore, although rotational operation control for slats is performed by rotating a slat angle adjusting motor during the inputting operation of the inputting switch, because there is a time lag between the inputting operation of the inputting switch and the rotational operation of the slat, it is extremely difficult to perform fine adjustments of the slat orientation.

The present invention is the result of contemplation on the conventional problem areas of this type, and the object thereof is to provide a stationary remote control transmitting device that displays, on a displaying unit on the jog dial rotation center side, the rotational operation directions of the jog dial, to provide guidance in the proper rotational operation direction.

An additional object is to provide a stationary remote control transmitting device enabling proper rotational control, with confidence, by matching the rotational direction or rotational angle of rotational operation of a jog dial to the rotational operation direction or rotational operation angle of the controlled device controlled by the rotational operation.

Another object is to provide a stationary remote control transmitting device capable of fine adjustment control of the rotational operation direction and rotational operation angle of a controlled device.

### SUMMARY OF THE INVENTION

In order to achieve the aforementioned objects, the stationary remote control transmitting device includes: a case having a bottom surface as a placement surface; an operating unit attached rotatably to the case; rotation detecting means for detecting the direction of rotation of the operating unit around a rotation center axis; a displaying unit for displaying a plurality of control content that controls controlled devices; an inputting switch, connected to the case, for selecting, by an inputting operation, specific control content from a plurality of control content that is displayed on the displaying unit; operating signal generating means for generating control data for controlling the controlled device using selected control content, from the direction of rotation detected by the rotation detecting means, in a control mode wherein specific control content has been selected by an inputting operation of the inputting switch; and RF transmission means for transmitting control data to a plurality of controlled devices through an RF (radio frequency) signal; wherein: a displaying unit is attached to a surface of the case that is exposed on the rotation center axis side of a rotational movement path of the operating unit; wherein in a control mode wherein control content for rotational operation control of the controlled devices has been selected: the displaying unit displays the rotational operation directions for the rotational operation control that has been selected; and the operating signal generating means generates control data for rotational operation controlling of the controlled device in a rotational operation direction displayed on the displaying unit from the rotational direction of the operating unit matching a rotational operation direction displayed on the displaying unit.

Because the displaying unit is attached to a surface of the case that is exposed at the rotation center axis side of the rotational movement path of the operating unit, the rotational operation directions for the operating unit are conveyed clearly to the operator.

Because the rotational direction of the controlled object, controlled by the rotational operation, is displayed on the displaying unit matching the rotational operation direction of the rotational operation of the operating unit, the rotational operation of the operating unit can be performed with confidence while the rotational operation direction for the control is confirmed on the operating unit.

In the stationary remote control transmitting device, the rotation detecting means detects the direction of rotation and angle of rotation around the center axis of an operating unit; and in a control mode wherein the operating signal controlling means has selected the control content for the rotational operation controlling of a controlled device: the displaying unit displays rotational operation directions for a selected operational control, and the rotational orientation of a controlled device selected by a rotational operation angle; and the operating signal generating means generates control data for rotational operation controlling of the controlled device to the rotational orientation displayed on the displaying unit, from the rotational direction and rotational angle of an operating unit that matches the rotational orientation displayed on the displaying unit.

Because the rotational orientation of that is specified by the rotational direction and rotational angle of the controlled device that is controlled by the rotational operation is displayed on the displaying unit matching the rotational operation direction and rotational angle of the rotational operation of the operating unit, it is possible to perform the rotational operation by adjusting the rotational direction or rotational angle of the operating unit while viewing, on the displaying unit, the rotational orientation being controlled.

Because the control data for the rotational operation controlling the controlled device to the rotational orientation displayed on the displaying unit is generated from the rotational direction and rotational angle of the operating unit, fine adjustment control of the rotational orientation of the controlled device can be performed through fine rotational operations of the operating unit.

In the stationary remote control transmitting device as set forth, the control content for rotational operation controlling of the controlled device is a control for rotational operation controlling of a slat of a blind.

Because the rotational orientation specified by the rotational direction and rotational angle of the slats is displayed on the displaying unit, rotational operations can be performed for the rotational operation direction and rotational angle of the operating unit, based on the rotational orientation displayed on the displaying unit.

In the stationary remote control transmitting device as set forth, the operating unit is formed in an annular shape around a rotational center axis; and the displaying unit is attached to a surface of a case that is exposed at an opening that surrounds the annular operating unit.

Because the displaying unit is exposed in an opening that is surrounded by the annular operating unit, the rotational operation directions for the operating unit are conveyed clearly to the operator.

The stationary remote control transmitting device has a case having a bottom surface as a placement surface; an operating unit attached rotatably to the case; rotation detecting means for detecting the direction of rotation of the operating unit around a rotation center axis; a displaying device, attached to a surface of a case that is exposed to the rotational center axis side of a rotational movement path of the operating unit, for displaying a plurality of controlled devices and displaying a plurality of control contents for controlling the respective individual controlled devices; an inputting switch, attached to the case, for selecting, through an inputting operation, a specific controlled device and control content from the plurality of controlled devices and plurality of control contents displayed on the displaying device; operating signal generating means for generating control data for controlling, by the selected control content, the selected controlled device in a control mode wherein a specific controlled device and a specific control content for controlling that controlled device have been selected by an inputting operation of the inputting switch; and RF transmitting means for transmitting a control data to a plurality of controlled devices through an RF signal; wherein: the displaying unit, in an inputting mode for selecting a controlled device, displays icons indicating each of a plurality of individual controlled devices at locations corresponding to the directions of installation of each of the controlled devices from the position of installation of the case, and provides a moving display of a cursor between icons around the same rotation as the rotational direction of the operating unit, detected by the rotation detecting means; and when there has been an inputting operation of the inputting switch, a control mode is generated wherein the controlled device that is displayed by the icon at the location of display of the cursor is defined as the controlled device that has been selected by the inputting operation of the inputting switch.

Because the control data is transmitted to the controlled device through an RF signal, it is possible to keep the relative orientation between the case and the plurality of controlled devices constant, without moving the remote control transmitting device depending on the location of the controlled device. Because, in the inputting mode wherein the controlled device is selected, icons indicating each of the plurality of controlled devices are displayed on the displaying device at positions corresponding to the directions of installation of the individual controlled devices, which maintain a fixed relative positioning with the case, the operator becomes aware of the relationship between the icons that are displayed on the display unit and the controlled device to be controlled, without any sense of unease.

Because the direction of movement of the cursor that moves between the icons matches the rotational operation direction of the operating unit, it is possible to select a controlled device through moving the cursor through rotational operation of the operating unit with the same rotation as the installation locations matching the directions of installation of the plurality of controlled devices.

In the stationary remote control transmitting device as set forth, the displaying device, in the inputting mode for selecting the control content, displays chained control content for controlling by chaining the control of a plurality of controlled devices; and the operating signal generating means, in a control mode wherein specific chained control content, displayed on the displaying device, has been selected through an inputting operation of the inputting switch, generate control data for chained control of a plurality of controlled devices in accordance with the selected chained control content.

Because control data for chained control of a plurality of controlled devices is generated through selecting specific chained control content that is displayed on the displaying unit, there is no need to perform inputting operations for inputting switches for each control content.

In the stationary remote control transmitting device the operating unit is formed in an annular shape around a rotational center axis; and the displaying unit is attached to a surface of a case that is exposed to an opening that surrounds the annular operating unit.

Because the displaying unit is exposed in an opening that is surrounded by the annular operating unit, the rotational operation directions for the operating unit are conveyed clearly to the operator.

Given the invention above, the displaying unit is disposed in the center of the operating unit for rotational operation, making it possible to use the display of the displaying unit to convey to the operator, without error, the rotational operation directions for the operating unit, which change depending on the control content.

Additionally, because the rotational operation directions for the controlled device are displayed on the displaying unit and the direction that is displayed on the displaying unit matches the rotational operation direction of the annular operating unit for performing the rotational operation control, rotational operations can be performed with confidence.

Because in the invention as set forth above, the rotational orientation of the controlled device that is controlled is displayed in the displaying unit, the rotational operation can be performed without error with the rotational direction and rotational angle of the operating unit being guided by the displaying unit.

Fine adjustment control of the rotational operation control of the controlled device can be performed through the rotational angle of the operating unit for the rotational operations.

Also, the rotational operation of the slats can be controlled through the rotational operation of the operating unit without unease while performing the rotational operations. Additionally, because the rotational operation angle of the slats can be adjusted in accordance with the rotational angle of the operating unit, it is possible to perform fine adjustments on the rotational orientation of the slats through fine rotational operations.

In the inventions as set forth above, because the rotational operation directions for the operating unit matching the rotational operation directions of the rotational operation control that has been selected are displayed on the displaying unit in the opening that is surrounded by the annular operating unit, the operation directions are conveyed clearly to the operator. Furthermore, the dimensions of the case can be miniaturized because the displaying unit is attached on the inside of the opening that is surrounded by the annular operating unit.

In the invention, icons representing the controlled devices are displayed on the displaying device matching the directions of installation of a plurality of controlled devices, making it possible to select, without error, the controlled device to be controlled.

Furthermore, because the operating unit is operated rotationally in the same rotation as the installation locations of the plurality of controlled devices matching the direction of the installation of the plurality of controlled devices, the operating unit can be operated rotationally with no confusion regarding the locations of installation of the controlled devices.

In the invention, the plurality of control content corresponding to the plurality of controlled devices can be controlled through an inputting operation of a single inputting switch.

### BRIEF DESCRIPTION OF THE DRAWINGS

FIG. 1 is an oblique view of a stationary remote control transmitting device as set forth in an embodiment according to the present invention.

FIG. 2 is a lengthwise cross-sectional diagram of the stationary remote control transmitting device of FIG. 1.

FIG. 3 is an exploded oblique view, from above, of each part of the stationary remote control transmitting device of FIG. 1.

FIG. 4 is an exploded oblique view, from below, of each part of the stationary remote control transmitting device of FIG. 1.

FIG. 5 is a block diagram illustrating the circuit structure of the stationary remote control transmitting device of FIG. 1.

FIG. 6 is an oblique view illustrating the state of the use of the stationary remote control transmitting device of FIG. 1.

FIG. 7 is an explanatory diagram illustrating a display that is displayed on a liquid crystal display element when adjusting the television audio volume.

FIG. 8 is an explanatory diagram illustrating a display that is displayed on a liquid crystal display element when controlling the closing of blinds.

FIG. 9 is an explanatory diagram illustrating a display that is displayed on a liquid crystal display element when selecting chained control content.

FIG. 10 is an explanatory diagram illustrating the display that is displayed on a liquid crystal display element according to another embodiment.

### DETAILED DESCRIPTION OF THE INVENTION

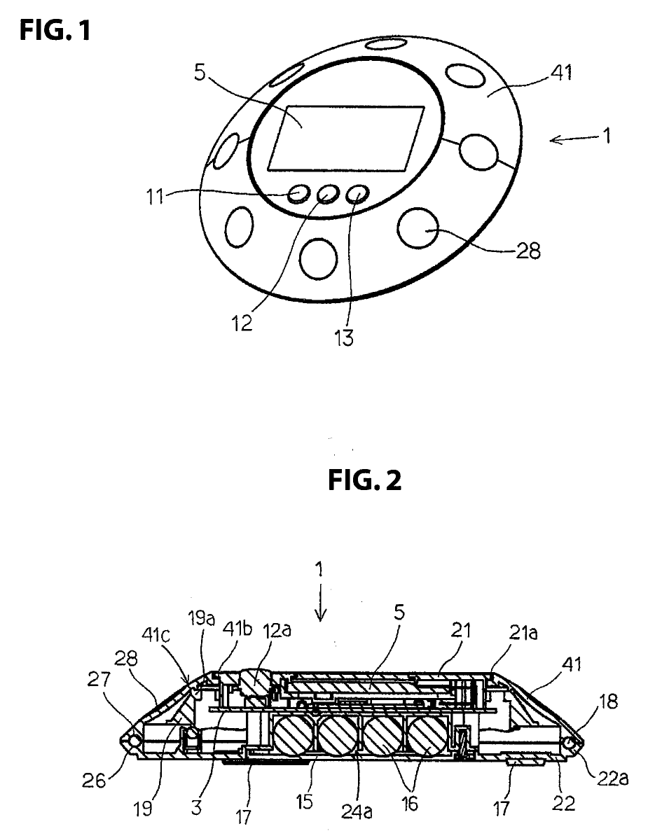

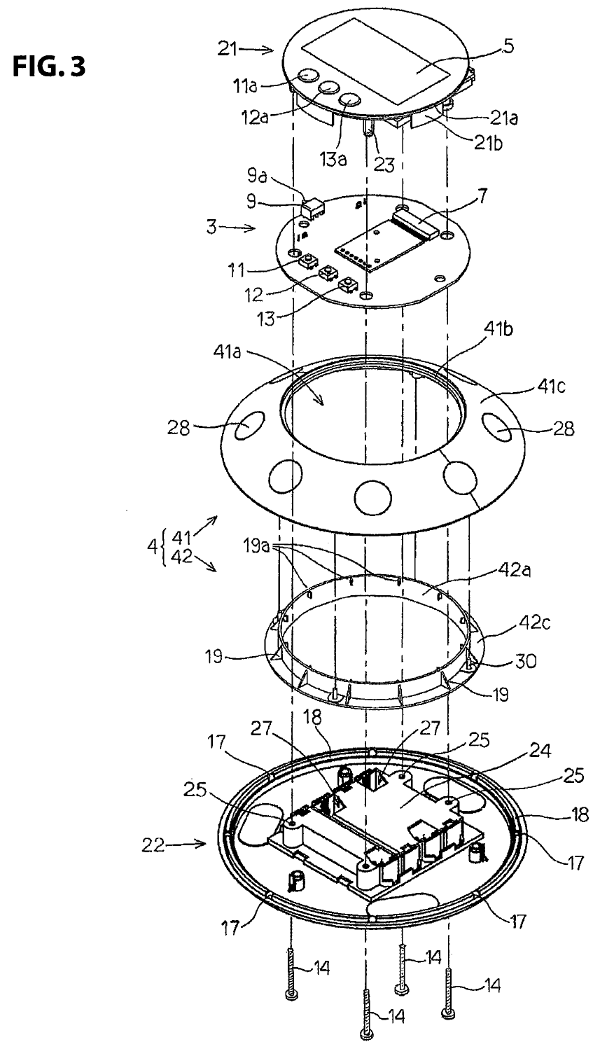

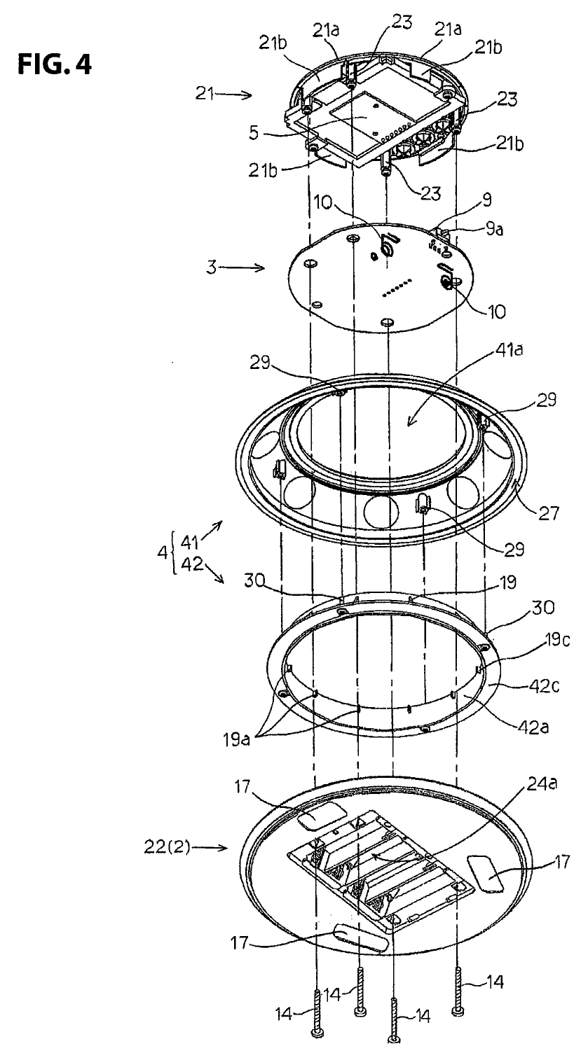

A stationary remote control transmitting device 1 as set forth in an embodiment according the present invention will be described below in reference to FIG. 1 through FIG. 9. FIG. 1 is an oblique view of a stationary remote control transmitting device 1; FIG. 2 is a lengthwise cross-sectional diagram of the same; FIG. 3 is an assembly oblique exploded view when seen from above the stationary remote control transmitting device 1; and FIG. 4 is an assembly oblique exploded view when viewed from below.

As illustrated in FIG. 3 and FIG. 4, the stationary remote control transmitting device 1 is provided with: an insulated case 2, structured from a small diameter disk portion 21 and a large diameter disk portion 22; a circular printed wiring board 2 that is attached interposed between the small diameter disk portion 21 and the large diameter disk portion 22; an annular operating unit 4 structured from a ring-shaped jog dial 41 and an operating ring 42; and three inputting switches 11, 12, and 13, near operating buttons; and a liquid crystal display element 5, on the front surface side of the small diameter disk portion 21.

The small diameter disk portion 21 is formed in a disk shape from synthetic plastic, and the liquid crystal display element 5 is attached from the bottom surface side (the bottom surface in FIG. 2), where the display screen of the liquid crystal display element 5 faces the inside of a rectangular opening that connects to the front surface side. Moreover, the respective operating buttons 11a, 12a, and 13a of the three inputting switches 11, 12, and 13 are attached so as to protrude on the front surface side, along one side of the rectangular shaped opening, so as to be attached at the positions of the inputting switches in 11, 12, and 13, which are each mounted on the printed wiring board, when the printed wiring board 3 is attached on the bottom surface side.

The outer peripheral edge portion 21a of the small diameter disk portion 21 has a circular contour, where guide pieces 21b, having circular arc shapes, are provided perpendicularly from four locations at 90° intervals along the contour of the outer peripheral edge portion 21a, slightly towards the center on the bottom surface side of the outer peripheral edge portion 21a. (See FIG. 4.) In a cylindrical inside surface of the inner peripheral edge that is formed by a center opening 41a of a jog dial 41, the inner diameter of the inside surface on the top side is somewhat longer than the outer diameter of the outer peripheral edge portion 21a of the small diameter disk portion 21, by a round step portion 41b, and the inner diameter of the inside surface on the bottom side is smaller than the outer diameter of the outer peripheral edge portion 21a and slightly larger than the diameter of the circle that is formed by the 4 guide pieces 21b. This causes the jog dial 41, which is assembled from above the center opening 41a, to contact the outer peripheral edge portion 21a, on the step portion 41b, to control the movement upward relative to the small diameter disk portion 21, and the inside surface on the top side and the inside surface on the bottom side slides along the outer peripheral edge portion 21a of the small diameter disk portion 21 and the guide pieces 21b, respectively, to be guided so as to be able to rotate.

On the bottom surface of the small diameter disk portion 21, screw receptacle protrusions 23, wherein screw threads have been provided on the cylindrical inner surfaces thereof, are provided perpendicularly in another four locations in order to screw screws 14, which pass through the printed wiring board 3 and the large diameter disk portion 22, to the screw receptacle protrusions 23. The outer diameter of these screw receptacle protrusions 23 is greater than the inner diameter of through-holes 31 that are provided in four locations in the printed wiring board 3, and thus the gap between the bottom surface of the small diameter disk portion 21, which is secured through screwing, and the printed wiring board 3 is at a height that is equal to that of the screw receptacle protrusions 23, where that height is higher than the height of each of the circuit components that are mounted on the printed wiring board 3, where the inputting switches 11, 12, and 13 are at a height so as to make contact with the bottom surface of each of the operating buttons 11a, 12a, and 13a when not pushed.

Along with the aforementioned inputting switches 11, 12, and 13, a microcontroller 7, RF communications module 8, and lever-type detecting switch 9 are mounted together with the drivers for the liquid crystal display element 5 on the front surface of the printed wiring board 3. The lever-type detecting switch 9 is mounted on the periphery of the printed wiring board 3 so that a movable terminal 9a, with which moves in a circular path on the printed wiring board 3, protrudes to the outside, in the radial direction, from the edge of the printed wiring board 3. Additionally, on the bottom surface of the printed wiring board 3 is attached a pair of wire contacts 10 that connect to one edge of a power supply pattern on the front surface side.

The large diameter disk portion 22 is formed from synthetic plastic into a disk shape having a diameter that is larger than the outer diameter of the small diameter disk portion 21, and is provided with a bottom guide groove 26, which is semicircular in its cross section, on the front surface of the outer peripheral edge portion 22a, along the circular outer periphery thereof. As illustrated in FIG. 3, this bottom guide groove 26 accommodates eight balls 17 that move within the bottom guide groove 26, and circular arc-shaped spacers 18 that maintain the gaps between the balls 17. The spacers 18 are formed as long and thin linear shapes from a flexible material, such as silicone, which has little friction with the synthetic plastic from which the large diameter disk portion 22 is formed, and thus by housing the spacers 18 along the ring-shaped bottom guide groove 26, the spacers 18 are formed into circular arc shapes conforming to the bottom guide groove 26. The bottom guide groove 26 and the balls 17 of the outer peripheral edge portion 22a guide the jog dial 41 so as to be able to rotate freely around the center axis thereof.

A box-shaped battery housing portion 24 is formed integrally with the center of the front surface side of the large diameter disk portion 22. Battery housing indentation portions 24a within the battery housing portion 24 are open on the bottom surface side, and house four batteries 16 (shown in FIG. 2) from the bottom surface side. Contact through-holes 27 permits the tips of a pair of wire contacts 10 facing the battery housing indented portion 24a when the printed wiring board 3 is layered onto the front surface side of the large diameter disk portion 22 and which are provided standing from two different locations of the battery housing portion 24, to connect to the positive terminal and the negative terminal of the batteries 16 housed in the battery housing indented portions 24a. The direct current power supply of the four batteries 16, which are connected in series within the battery housing indentation portion 24a, is supplied to each of the circuit components mounted on the printed wiring board 3, through the contacts 10 and the power supply pattern of the printed wiring board 3.

Additionally, through-holes 25, through which the four screws 14 pass, are provided in four locations on the periphery of the battery housing portion 24 so as to extend to the bottom surface of the large diameter disk portion 22. The openings on the bottom surface side of the through-holes 25 are the openings for the battery housing indented portion 24a, and are covered with the battery cover 15 (shown in FIG. 2) that is screwed to the bottom surface side.

The stationary remote control transmitting device 1 of the present embodiment is used while placed on a table, or the like, and so non-skid pads 17 are adhered in three locations, at 120° intervals, on the bottom surface side of the large diameter disk portion 22, so that the stationary remote control transmitting device 1 will not move at the time of an inputting operation.

The jog dial 41 is formed into a truncated circular cone shaped wherein a circular center opening 41a is open at the peak portion of a shallow dish shape, where the ring-shaped rotational operating surface 41c formed between the small diameter inner peripheral edge that is the contour of the center opening 41a and the large diameter outer peripheral edge slants downwards towards the outside from the center. As described above, the inside surface of the inner peripheral edge side, which faces the center opening 41a, has an inner diameter of the inside surface on the top side that is larger than the inner diameter of the inside surface on the bottom side by a step portion 41b, and thus by fitting to the outer peripheral edge portion 21a of the small diameter disk portion 21 and the guide pieces 21b, the jog dial 41 is prevented from coming out in the upper direction of the small diameter disk portion 21, and guided so as to be able to rotate freely around the center axis of the small diameter disk portion 21.

The outer diameter of the jog dial 21 is essentially equal to the outer diameter of the large diameter disk portion 22, where a top guide groove 27, having a semicircular shape in the cross section thereof, symmetrical to the bottom guide groove 26 of the large diameter disk portion 22, is formed in the shape of a circle along the outer peripheral edge at the bottom surface of the outer peripheral edge portion thereof. Given this structure, when the jog dial 41 is placed on the large diameter disk portion 22, so as to be coaxial therewith, the top guide groove 27 and the bottom guide groove 26 face each other with the balls 17 and the spacers 18 housed so as to be able to roll or slide freely between the top guide groove 27 and the bottom guide groove 26, so that the jog dial 41 is guided so as to be able to rotate freely around the center axis of the large diameter disk portion 22.

On the front surface of the rotational operating surface 41c, circular non-slip indentation portions 28, which are shaped so as to prevent slipping of the rotational operation, are provided indented at essentially equal intervals around the center axis, and, on the bottom surface thereof, positioning cylindrical portions 29 are provided integrally at 90° angles around the center axis, extending perpendicularly.

The operating ring 42 is formed from a cylindrical portion 42a with an inner diameter that is somewhat larger than the outer diameter of the printed wiring board 3, and a flange portion 42c that protrudes in the horizontal direction towards the outside from the bottom surface of the cylindrical portion 42a. A plurality of bracket pieces 19 are secured at essentially equal intervals around the center axis between the cylindrical portion 42a and the flange portion 42c, and the tip portions of each bracket piece 19 are operating protrusions 19a that pass through the cylindrical portions 42a.

Positioning protrusions 30, which mate with the positioning cylinder portions 29, are provided standing on the front surface of the flange portion 42 of the operating ring 40, facing the positioning cylindrical portions 29 of the jog dial 41, so that after the positioning protrusions 30 and the positioning cylindrical portions 29 are fitted together, the two are secured using an adhesive, with the operating ring 42 secured to the bottom surface side of the rotational operating surface 41c of the jog dial 41.

The assembly of the stationary remote control transmitting device 1, set forth above, is combined into a single unit by screwing four screws 14 from the bottom surface side of the large diameter disk portion 22 through the large diameter disk portion 22 through-holes 25 and the printed wiring board 3 through-holes 31, into the screw receptacle protrusions 23 of the small diameter disk portion 21, as shown in FIG. 2 and FIG. 3, with the jog dial 41, with the operating ring 42 secured on the bottom surface thereof, between the small diameter disk portion 21 and the large diameter disk portion 22.

In the state wherein the assembly has been screwed together, in sequence from the top, the small diameter disk portion 21, the jog dial 41, the operating ring 42, the printed wiring board 3, and the large diameter disk portion 22 are disposed on top of each other so as to be coaxial, and as illustrated in FIG. 2, the jog dial 41 is guided, by each of the outer peripheral edge portions of the small diameter disk portion 21 and the large diameter disk portion 22, so as to be able to rotate freely around the center axis.

Additionally, a cylindrical portion 42a of the operating ring 42 is disposed so as to be able to rotate freely around the periphery of the lever-type detecting switch 9 that is mounted on the printed wiring board 3, so that the movable terminal 9a of the lever-type detecting switch 9 is disposed on the same periphery as the operating protrusion 19a that protrudes to within the cylindrical portion 42a, and, as described above, the respective individual operating buttons 11a, 12a, and 13a of the inputting switches 11, 12 and 13, make contact with the actuators of the inputting switches 11, 12, and 13 that are mounted on the printed wiring board 3.

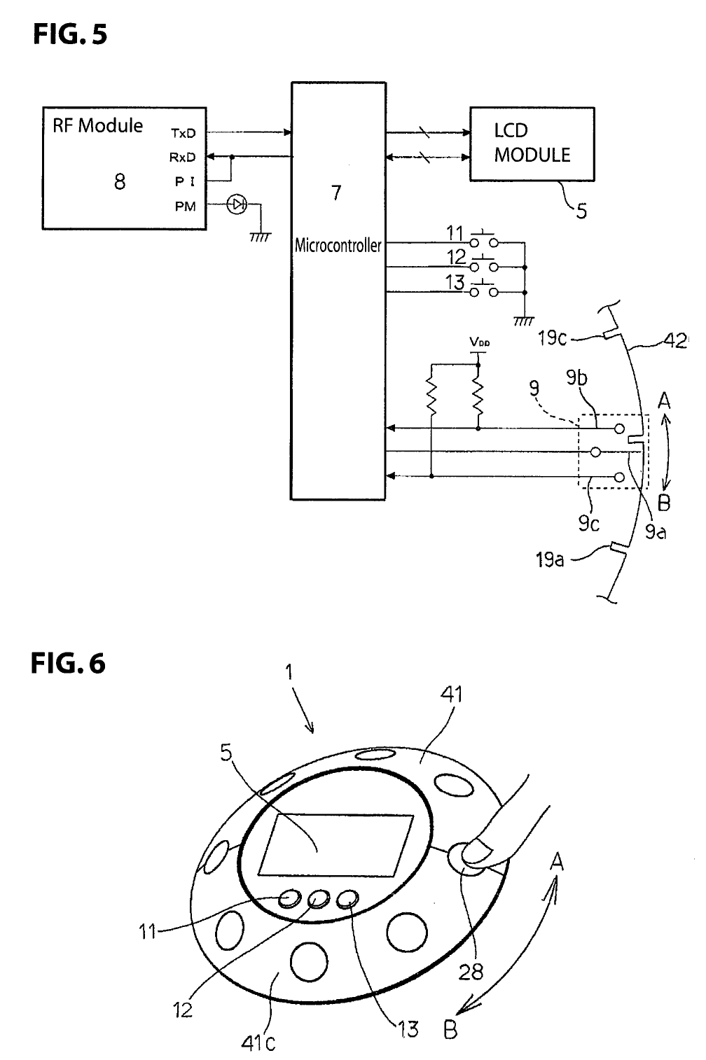

FIG. 5 is a block diagram illustrating the circuit components for structuring the stationary remote control transmitting device 1, wherein the lever-type switch 9, the inputting switches 11, 12, and 13, the liquid crystal display element 5, and the RF communications module 8 are connected to the microcontroller 7.

The lever-type detecting switch 9 is a rotation detecting element for detecting a rotational direction and a rotational angle due to a rotational operation on the jog dial 41, where, when there is a rotational operation of the jog of 41 in one direction (for example, the direction A in FIG. 5), the operating protrusions 19a that move in that direction of rotation strike the movable terminal 9a of the lever-type detecting switch 9, causing the movable terminal 9a to contact the stationary terminal 9b in that direction of rotation, causing a pulse signal due to the contact between the movable terminal 9a and the stationary terminal 9b. On the other hand, when the jog dial 41 is operated rotationally in the opposite direction (for example, direction B in FIG. 5), then, similarly, the movable terminal 9a and the stationary terminal 9c will make contact in that direction of rotation, producing a pulse signal due to the contact between the movable terminal 9a and the stationary terminal 9c. If a pulse signal that is inputted from the lever-type detecting switch 9 is inputted from between the movable terminal 9a and the stationary terminal 9b, then the microcontroller 7 determines that there is a rotational operation in the A direction, but if inputted from between the movable terminal 9a and the stationary terminal 9c, then the microcontroller 7 determines that there has been a rotational operation in the direction B. Additionally, because the operating protrusions 19a are provided at equal angle intervals around the center of the jog dial 41, the angle of rotation of the jog dial 41 can be determined by the number of occurrences of the inputted pulse signals, and the speed of rotation thereof can be determined by the frequency of occurrences of the pulse signals within a specific unit time period.

Note that the movable terminal 9a has elasticity recover to the center position, so that when the operating protrusions 19a cause the movable terminal 9a to make contact with either of the stationary terminals 9b or 9c, against the elastic force that is received from the movable terminal 9a, and the operating protrusions 19a go past the movable terminal 9a, then the elastic force that is received from the movable terminal 9a is released, so that the operator receives the feel of a click each time an operating protrusion 19a passes by the movable terminal 9a, making it possible to obtain a feel of the rotational operation, including the amount of rotation of the rotational operation angle.

The microcontroller 7, upon an input of a pulse signal indicating a rotational operation of the lever-type detecting switch 9 and an operating signal from an inputting switch 11, 12, and 13, controls the display of the liquid crystal display element 5, such as control so as to move the cursor 6 in accordance with the input, and controls the communications operation of the RF communications module 8. When an operating signal is inputted from the inputting switch 11, at this time the controlled device, control operation for a controlled device, or other control content indicated by the white cursor 6 on the control display device 5 is selected, and when an operating signal from the inputting switch 12 is inputted, then radio communications are performed between the controlled device that is to be controlled and the RF communications module 8, and the operating status thereof is displayed on the liquid crystal display element 5, and when an operating signal from the inputting switch 13 is inputted, then the selection of the control content that displays the controlled device or the content of the control operation for the controlled device, selected by the inputting switch 11, is canceled. Additionally, the movement of the cursor 6 that is displayed on the liquid crystal display element 5 is controlled, as described below, by the pulse signals from the lever-type detecting switch 9, and when control content for rotationally controlling the controlled device is selected by the inputting switch 11, then control data for rotationally controlling the controlled device is generated in accordance with the pulse signal count, and outputted to the RF communications module 8.

The RF communications module 8 is connected to the microcontroller 7 through asynchronous bidirectional indications based on UART (Universal Asynchronous Receiver Transmitter). Furthermore, the RF communications module 8 performs radio communications with the controlled device, specified in advance through pairing, using a standard based on the Radio Communications Standard IEEE 802.15.4, and when a command is received from the microcontroller 7, the operating status of the controlled device is received, and when control data for controlling the operation of the controlled device is received from the microcontroller 7, then the control data is sent to the controlled device through radio communications, to cause the execution of operations in accordance with the control data.

The operation of the stationary remote control transmitting device 1, structured as set forth above, will be described below using FIG. 6 through FIG. 9. When in a standby state wherein the stationary remote control transmitting device 1 is not used, the microcontroller 7 operates in a sleep mode that only detects inputs from the inputting switches 11, 12, 13, and the lever-type detecting switch 9, in order to minimize wear on the batteries 16.

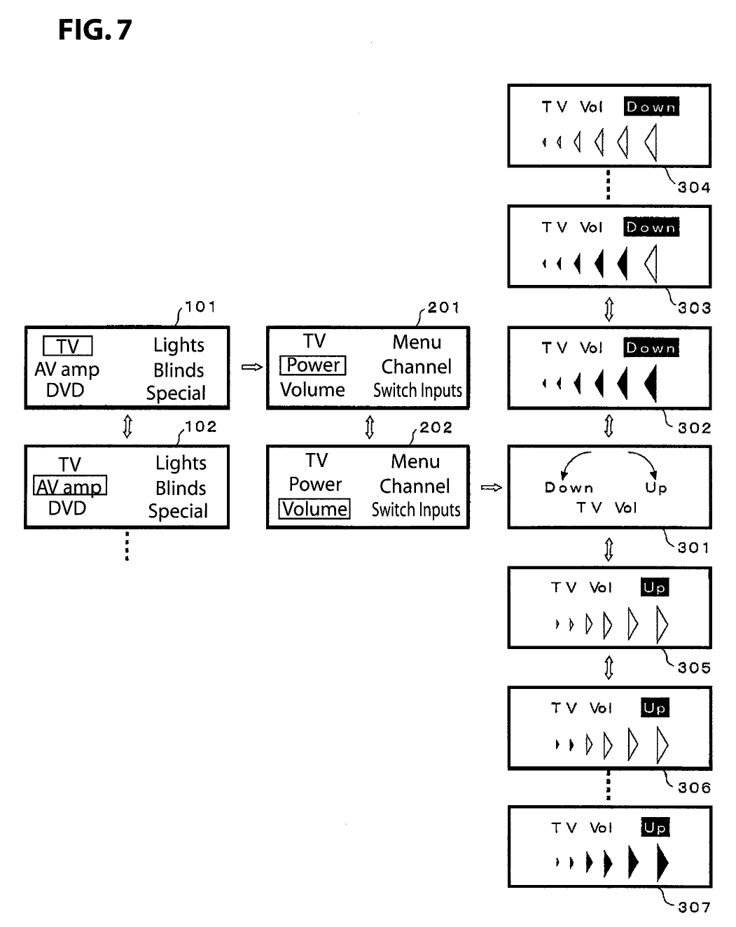

In the initial state wherein an input has been detected from any of the inputting switches 11, 12, or 13, or from the lever-type detecting switch 9, the liquid crystal display element 5 displays the main menu illustrated by 101 in FIG. 7, and displays the cursor 6 that is shown in reverse video in the display position of the television, which is one of the controlled devices. The main menu is the inputting mode for selecting the controlled device to be controlled, and as illustrated in FIG. 6, in selecting the controlled device, the cursor 6 that is displayed on the liquid crystal display element 5 is moved by rotating the jog dial 41 around the center axis thereof by pressing on the non-slip indentation portion 28 with a finger.

The cursor 6 moves on the display screen of the liquid crystal display element 5 so as to match the direction of rotation of the jog dial 41, and when, for example, the jog dial 41 is operated rotationally in the A direction in FIG. 6 (the counterclockwise direction), then a series of a plurality of pulse signals is inputted into the microcontroller 7 from between the movable terminal 9a and the stationary terminal 9b, and the microcontroller 7 detects the rotational operation in the A direction, and moves the cursor 6, which is at the display position of the television, to the display position of the AV amplifier, which is in the same direction as the A direction indicated by 102.

After the cursor 6 has been moved, through this type of rotational operation, to the display position of the controlled device to be controlled, then an inputting operation is performed by the inputting switch 11. Here a television sound volume operation will be performed, so when the cursor 6 is moved to the display position of the television in the main menu (101) and an inputting operation is performed by the inputting switch 11, then the display screen on the liquid crystal display element 5 is switched to the Television menu inputting mode (201). The cursor 6 is moved to match the direction of the rotational operation of the jog dial 41 in the same manner as in the main menu, and in order to operate the volume, the jog dial 41 is operated rotationally in the A direction, and when the cursor 6 is moved to the display position of the Volume (202), an inputting operation is performed by the inputting switch 11. When this is done, the microcontroller 7 moves to a controlling mode wherein control content for controlling the television volume has been selected. Note that when the inputting switch 13 is inputted, in any display screen that displays the Television menu, the display screen returns to the main menu (101), one level back.

When the cursor 6 is at the display position of the Volume (202) and an inputting operation is performed by the inputting switch 11, then the display screen of the liquid crystal display 5 is switched to the inputting mode (301) for adjusting the volume. In the inputting mode (301) for adjusting volume, the control content for controlling the volume up or down, along with the rotational operation directions for the jog dial 41 in order to perform these controls, are shown by arrows around the rotational center by the liquid crystal display element 5, which is disposed on the center side of the jog dial 41. That is, the rotational operation directions of the jog dial 41 for producing the control data for this control content (volume up or volume down) is indicated by arrows around the same center axis on the center side of the jog dial 41, thus enabling the operator to perform the rotational operation without mistaking the rotational operation direction of the jog dial 41 for the control content. When the jog dial 41 is operated rotationally in the A direction, control data for reducing the sound volume of the television is sent to the television, and not only does the sound volume decrease in accordance with the rotational angle in the A direction, but also there is a switch to a display wherein the black triangle marks indicate indicated that the volume has been reduced (302 through 304). Additionally, when the jog dial 41 is operated rotationally in the B direction, control is performed to increase the sound volume of the television, and not only does the sound volume increase in accordance with the rotational angle in the B direction, but also the black triangle mark that indicates the sound volume moves to display the increase (305 through 307).

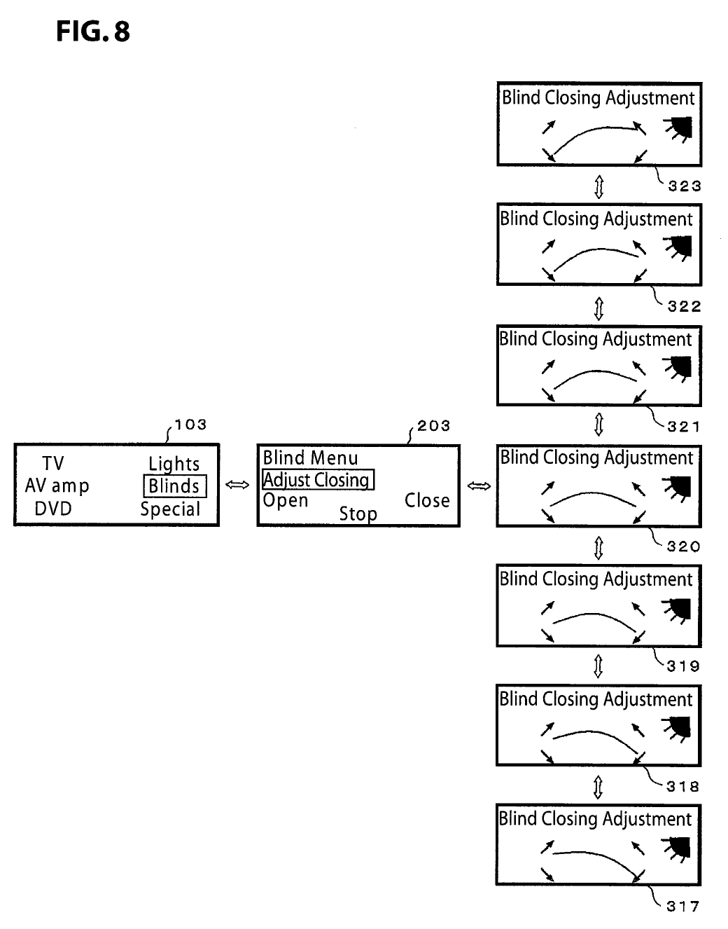

Next, when the closing of the blinds is to be controlled, then the a rotational operation is performed on the jog dial 41 in either the A direction or the B direction from the main menu illustrated by 101 in FIG. 7 to move the cursor 6 to the display position of the blinds in FIG. 8 (103), and an inputting operation is performed by the inputting switch 11. The display screen on the liquid crystal display element 5 switches to the inputting mode (203) for the Blind menu, and when the cursor 6 is moved to Adjust Closing in this inputting mode and an inputting operation is performed by the inputting switch 11, then the blind closing adjustment inputting mode (320), which shows the directions for opening and closing the blinds, is displayed. At the same time, the microcontroller 7 switches to a control mode wherein control content for controlling the blind opening adjustment has been selected.

In the blind closing adjustment inputting mode (320), the opening/closing status of the blinds, when seen from the side, is displayed in the liquid crystal display element 5, where the opening and closing directions match the directions of opening and closing through the rotational operation of the jog dial 41. That is, when there is a rotational operation in the counterclockwise direction (the A direction) on the jog dial 41, the blinds are rotationally controlled in the counterclockwise direction, when viewed from the right side, to narrow the gaps between the blinds, to increase the amount of light blocked, and when there is a rotational operation in the clockwise direction (the B direction), then the blinds are rotationally controlled in the clockwise direction, widening the gaps between the blinds, increasing the amount of light allowed.

The rotational control of the blinds is performed proportionately to the rotational angle of the jog dial 41, and when the jog dial 41 is operated rotationally in the A direction, the blinds are rotationally controlled to rotate to the left in accordance with the rotational angle thereof, and the display on the liquid crystal element 5 moves in a direction (the direction from 317 to 323 in FIG. 8) indicating that the blinds are gradually rotating to the left. Conversely, when there is a rotational operation in the B direction, rotational control is performed to rotate the blinds to the right in accordance with the rotational angle thereof, and the display on the liquid crystal display element 5 moves in a direction (the direction from 317 to 323 in FIG. 8) indicating that the blinds are gradually rotating to the right.

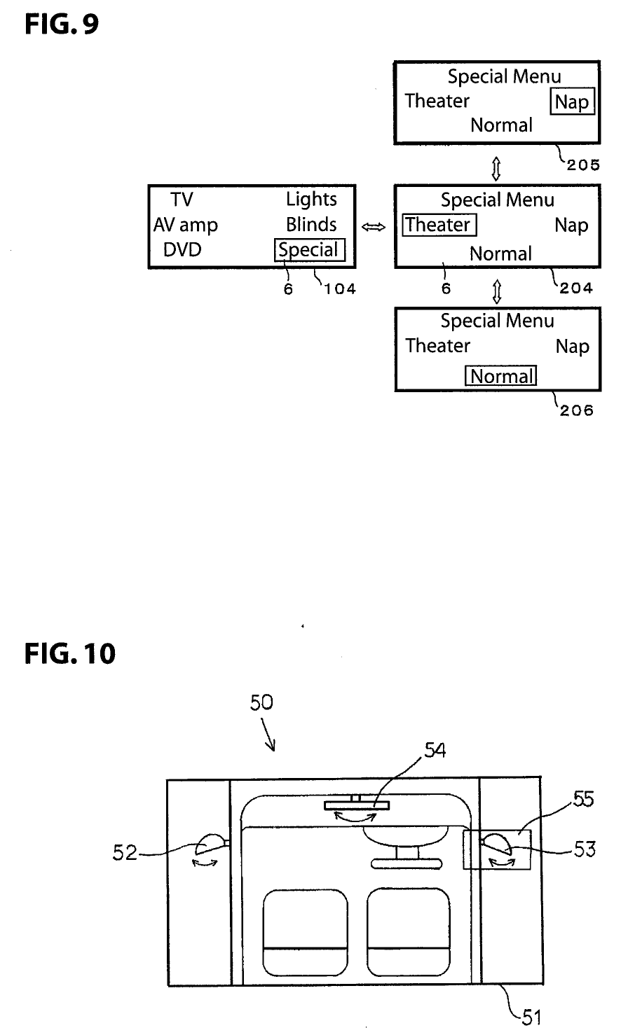

The stationary remote control transmitting device 1 can also perform chained control of a plurality of operations on a plurality of controlled devices, where this chained control is selected from “Special” on the main menu (103). When chained control content is selected, the jog dial 41 is rotationally controlled in either the A direction or the B direction to move the cursor 6 to the display position (104) of Special in FIG. 9, from the main menu illustrated by 101 in FIG. 7, and an inputting operation is performed by the inputting switch 11.

The display screen of the liquid crystal display element 5 switches to the Special menu inputting mode (204). The “Theater,” and “Nap” [better “Sleep”] that can be selected from the Special menu combine together control operations that one may wish to perform continuously in a series of a plurality of control operations on the plurality of controlled devices, and when, for example, “Nap” [“Sleep”] is selected, then control data is generated to not only perform control so as to turn OFF the controlled device, “Lights,” but also to perform closing adjustment control so as to minimize the amount of light allowed by the “Blinds,” and these control data are sent to the controlled devices.

In the Special menu inputting mode (204), each time the jog dial 41 is operated rotationally in either the A or B direction, the cursor 6 moves in the same direction between “Nap” [“Sleep”] (205), “Theater” (204), and “Normal” (206), and when there has been an inputting operation by the inputting switch 11, then the chained control content at the display position of the cursor 6 is selected. When “Theater” is selected, then, in addition to the chained control for “Nap,” [“Sleep,”] described above, control data is generated to turn ON the power supply of the “DVD,” and this control data is sent to the controlled devices. Note that the chained control content “Normal” can be set in advance by the user to record any desired settings for the control content for a plurality of controlled devices, and by storing the general control that is required for controlling a plurality of controlled devices simultaneously, it is possible to perform a plurality of control operations through a single selection, without performing control through inputting operations for each individually.

FIG. 10 illustrates the inputting mode for a main menu that is displayed on a liquid crystal display element 51 of a stationary remote control transmitting device 50 illustrating a second example of embodiment as set forth in the present invention, where structures that are identical or corresponding to those in the first example of embodiment are assigned identical codes, and explanations are given below. The remote control transmitting device 50 as set forth in this embodiment is provided secured to the side of the driver's seat in a passenger car in order to perform rotational operation control of the left and right side mirrors 52 and 53, and the back mirror 54, of the passenger car. Because the directions of each of the controlled devices 52, 53, and 54, which are subjected to rotational operation control are stationary from the installation position of the remote control transmitting device 50, on the schematic diagram illustrating the vicinity of the driver's seat of the passenger vehicle, the icons on the liquid crystal display element 51 showing the side mirrors 52 and 53 and back mirror 54 to be controlled (illustrated with the same numbers as the controlled devices) are shown essentially matching the directions from the installation position of the remote control transmitting device 50.

The cursor 55 that appears as a rectangular frame in the diagram for selecting the controlled device moves in the same rotation between the icons 52, 53, and 54 as the direction of rotation of the annular operating unit 4 of the remote control transmitting device 50, and the controlled device shown by the icon at the display position of the cursor 55 is selected through an inputting operation by the inputting switch 11.

Consequently, in the main menu illustrated in FIG. 10, the icons 52, 53, and 54 that indicate each of the controlled devices are actually shown on the liquid crystal display element 51 essentially matching the directions of the left and right side mirrors 52 and 53 and back mirror 54 that are to be controlled, relative to the position of installation of the stationary remote control transmitting device 50, making it possible for the operator to recognize, without error, the devices to be controlled, indicated by the icons 52, 53, and 54. Furthermore, the direction of movement of the cursor 55, which moves between the icons 52, 53, and 54, matches the rotational direction of the annular operating unit 4, making it possible to move the cursor 55 to any of the controlled devices with confidence.

When adjusting the rotational position of the right side mirror 53, a rotational operation is performed on the annular operating unit 4, so that, as illustrated in the figure, the cursor 55 moves to the display position of the icon 53, and an inputting operation is performed on the inputting switch 11 to select the right side mirror 53 as the controlled device. In the rotational position of adjusting mode for rotational operation controlling of the right side mirror 53, the rotational operation direction of the annular operating unit 4 matches the rotational control operation direction on the right side mirror 53, and the right side mirror 53 rotates proportionately to the rotational operation angle of the annular operating unit 4. Additionally, the rotational direction and rotational position of the right side mirror 53, controlled through the rotational operation of the annular operating unit 4, is displayed on the liquid crystal display element 51 (not shown), enabling the operator to gauge the rotational operation direction and the rotational operation angle from this display.

The stationary remote control transmitting device 1 according to the first example of embodiment as set forth above transmits control data to each controlled device using RF transmitting means, and so can be secured and located at any position without considering the directions towards the controlled devices, and because there are no constraints on the operation directions for the rotational operations on the annular operating unit 4, the operations can be performed from any direction. Consequently, it is possible to perform rotational operations on the annular operating unit 4 while checking the display of the liquid crystal display element 5 from any direction through repetitively displaying the same display at each specific rotational angle.

Although in each of the examples of embodiment set forth above, the operating unit 4 is of a size that covers the entire shape of the front surface of the case 2 to facilitate fine angle rotational operations through having a large jog dial 41 with a large diameter, the operating unit 4 may be of any given shape and size insofar as it is attached to a portion of the case 2 and the liquid crystal display element is attached in an opening on the center side thereof. For example, insofar as the operating unit is attached to the case 2 so as to be able to rotate, it need not necessarily be annular. When an operating unit that is not shaped as a ring is attached to a case 2, a displaying unit 51 is disposed towards the inside, which is the rotational center axis side, of a rotational path that is indicated by a circle or a circular arc.

Additionally, light-emitting displaying means, such as LEDs, may be attached to the rotational operating surface of the annular operating unit 4, and the light-emitting displaying means may be turned ON or OFF to indicate the specific control content that has been selected.

The present invention can be applied to stationary remote control transmitting devices for controlling controlled devices through rotational operations of an operating unit.

We claim:

1. A stationary remote control transmitting device comprising:
a case having a bottom surface as a placement surface;
an operating unit attached rotatably to the case;
a rotation detecting device detecting the direction of rotation of the operating unit around a rotation center axis;
a displaying unit displaying a plurality of control content that controls controlled devices;
an inputting switch, connected to the case, selecting, by an inputting operation, specific control content from a plurality of control content that is displayed on the displaying unit;
an operating signal generating device generating control data for controlling the controlled device using selected control content, from the direction of rotation detected by the rotation detecting device, in a control mode wherein specific control content has been selected by an inputting operation of an inputting switch; and
an RF transmission device transmitting control data to a plurality of controlled devices through an RF signal;
wherein the displaying unit is attached to a surface of the case that is exposed on the rotation center axis side of a rotational movement path of the operating unit;
wherein, in a control mode wherein control content for rotational operation control of the controlled devices has been selected the displaying unit displays rotational operation directions for the rotational operation control that has been selected; and
wherein the operating signal generating device generates control data for rotational operation controlling of the controlled device in the rotational operation direction displayed on the displaying unit from a rotational direction of the operating unit matching a rotational operation direction displayed on the displaying unit.

2. The stationary remote control transmitting device as set forth in claim 1, wherein:
the rotation detecting device detects a direction of rotation and an angle of rotation around the center axis of an operating unit; and
in a control mode wherein the operating signal controlling device selects the control content for the rotational operation controlling of a controlled device, the displaying unit displays rotational operation directions for a selected operational control, and the rotational orientation of a controlled device selected by a rotational operation angle; and
wherein the operating signal generating device generates control data for rotational operation controlling of the controlled device to the rotational orientation displayed on the displaying unit, from the rotational direction and rotational angle of an operating unit that matches the rotational orientation displayed on the displaying unit.

3. The stationary remote control transmitting device as set forth in claim 2, wherein the control content for rotational operation controlling of the controlled device is a control for rotational operation controlling of a slat of a blind.

4. The stationary remote control transmitting device as set forth in claim 1, wherein:
the operating unit is formed in an annular shape around a rotational center axis; and
the displaying unit is attached to a surface of a case that is exposed to an opening that surrounds the annular operating unit.

5. A stationary remote control transmitting device comprising:
a case having a bottom surface as a placement surface;
an operating unit attached rotatably to the case;
a rotation detecting device detecting the direction of rotation of the operating unit around a rotation center axis;
a displaying device, attached to a surface of a case that is exposed to the rotational center axis side of a rotational movement path of the operating unit, for displaying a plurality of controlled devices and displaying a plurality of control contents for controlling the respective individual controlled devices;
an inputting switch, attached to the case, selecting, through an inputting operation, a specific controlled device and control content from the plurality of controlled devices and plurality of control contents displayed on the displaying device;
an operating signal generating device generating control data for controlling, by the selected control content, the selected controlled device in a control mode wherein a specific controlled device and a specific control content for controlling that controlled device have been selected by an inputting operation of the inputting switch; and
an RF transmitting device transmitting control data to a plurality of controlled devices through an RF signal;
wherein the displaying device, in an inputting mode for selecting a controlled device, displays icons indicating each of a plurality of individual controlled devices at locations corresponding to the directions of installation of each of the controlled devices from the position of installation of the case, and provides a moving display of a cursor between icons around the same rotation as the rotational direction of the operating unit, detected by the rotation detecting device; and
wherein when there has been an inputting operation of the inputting switch, a control mode is generated wherein the controlled device that is displayed by the icon at the location of display of the cursor is defined as the controlled device that has been selected by the inputting operation of the inputting switch.

6. The stationary remote control transmitting device as set forth in claim 5, wherein:
the displaying device, in the inputting mode for selecting the control content, displays chained control content for controlling by chaining the control of a plurality of controlled devices; and
the operating signal generating device, in a control mode wherein specific chained control content, displayed on the displaying device, has been selected through an inputting operation of the inputting switch, generate control data for chained control of a plurality of controlled devices in accordance with the selected chained control content.

7. The stationary remote control transmitting device as set forth in claim 5, wherein:
the operating unit is formed in an annular shape around a rotational center axis; and
the displaying unit is attached to a surface of a case that is exposed to an opening that surrounds the annular operating unit.
